(19) United States
(12) Patent Application Publication
(10) Pub. No.: US 2008/0019612 A1
(43) Pub. Date: Jan. 24, 2008

(54) IMAGE SCALING DEVICE

(76) Inventor: Yukio Koyanagi, Saitama-shi (JP)

Correspondence Address: CONNOLLY BOVE LODGE & HUTZ LLP, 1875 EYE STREET, N.W., SUITE 1100, WASHINGTON, DC, 20036, US

(21) Appl. No.: 11/776,646

(22) Filed: Jul. 12, 2007

(30) Foreign Application Priority Data
Jul. 13, 2006 (JP) 2006-192370

(51) Int. Cl. G06K 9/32

(52) U.S. Cl. 382/300

(57) ABSTRACT

A range obtained by adding virtual pixels for “k” clocks on an outer side of effective pixels of an original image is set as a processing range. A representative value is calculated for each pixel block including 2×2 pixels adjacent to one another in the processing range. Pixel values of the respective pixels in an interpolation position corresponding to a predetermined scaling factor are calculated by applying an interpolation operation to the representative value calculated such that an effective range 22 of an image formed by the representative value is shifted further to the outer side than the effective range 21 of the original image. The interpolation operation is applied to the representative value, the effective range of which is shifted to the outer side in this way. Consequently, even if the effective range of the image formed by the interpolation value is shifted to an inner side, an effective range obtained as a result of the shift is the same as the effective range of the original image.

### BACKGROUND OF THE INVENTION

1. Field of the Invention

The present invention relates to an image scaling device. More particularly, the present invention is suitably used for an apparatus that performs enlargement and reduction of digital images.

2. Description of the Related Art

Conventionally, as a method of performing enlargement or reduction of an image with simple processing, there is known a method of repeating or curtailing same pixels at predetermined intervals. For example, it is possible to easily obtain an enlarged image 1.2 times as large as an original image by inserting, every five pixels, a pixel having a pixel value same as a fifth pixel in each of an X direction and a Y direction. Conversely, it is possible to easily obtain a reduced image 0.8 times as small as the original image by deleting one pixel every five pixels.

However, when pixels are inserted or curtailed at fixed intervals in this way, there is a disadvantage that an image after the enlargement or the reduction is distorted. Therefore, in performing enlargement or reduction of images with high accuracy, methods employing interpolation processing without such a disadvantage are generally used (see, for example, Japanese Patent Application Laid-Open No. 11-353473).

Among the methods, there is an image scaling system employing a combination of resampling processing and interpolation processing (see, for example, Japanese Patent Application Laid-Open No. 9-295265).

In the technique disclosed in Japanese Patent Application Laid-Open No. 9-259265, for example, in the case of processing for enlarging (or reducing) an image to an image “s” times as large (or small) as the image, first, resampling is performed at intervals of 1/S times as small as pixel intervals of the original image. Consequently, the number of resample points increases to be “s” times as large as the number of pixels of the original image both vertically and horizontally. Subsequently, pixel values of the resample points are calculated by an interpolation operation using pixel values of the original image near the resample points. The pixel values of the resample points calculated are drawn at the original pixel intervals same as those of the original image to obtain an enlarged or reduced image.

There is also proposed a technique for calculating an average of plural pixel data in an original image and applying an interpolation operation to the average calculated to obtain an enlarged or reduced image of the original image (see, for example, Japanese Patent Application Laid-Open Nos. 2002-152501 and 2001-13947).

However, in the conventional techniques including those disclosed in the patent documents described above, an effective range of the enlarged or reduced image generated by the interpolation processing is shifted by a predetermined amount in an obliquely inward direction with respect to an effective range of the original image. For example, as shown in FIG. 10, in obtaining one interpolated pixel from a 2×2 matrix (pixel block), interpolated pixels indicated by ● are generated in positions shifted by vertical 0.5 clock (an interval of one pixel is equivalent to 1 clock)×horizontal 0.5 clock with respect to positions of original pixels indicated by 0. Consequently, a peripheral portion of the original image is lost.

### SUMMARY OF THE INVENTION

The present invention has been devised to solve the problems and it is an object of the present invention to make it possible to prevent the inconvenience that, when enlargement or reduction of an image is performed by interpolation processing, a peripheral portion of an original image is lost because an enlarged or reduced image is shifted in an obliquely inward direction with respect to the original image.

In order to solve the problems, in the present invention, a range obtained by adding virtual pixels for “k” clocks on an outer side of an effective range of an original image is set as a processing range, a representative value is calculated for each pixel block including m×n pixels adjacent to one another in the processing range, and an interpolation operation is applied to the representative value calculated to calculate pixel values of respective pixels in an interpolation position corresponding to a predetermined scaling factor.

According to the present invention constituted as described above, after virtual pixels for “k” clocks are added on an outer side of effective pixels of an original image, a representative value is calculated for each pixel block including m×n pixels adjacent to one another. Thus, an effective range of an image formed by the representative value is shifted further to the outer side than the effective range of the original image by a predetermined amount. When the interpolation operation is applied to the representative value with the effective range shifted to the outer side in this way, an effective range of an image formed by interpolated pixels is shifted to an inner side. However, an effective range obtained as a result of the shift is the same as the effective range of the original image. Consequently, even when enlargement or reduction of an image is performed by the interpolation processing, it is possible to prevent the inconvenience that a peripheral portion of the original image is lost.

### BRIEF DESCRIPTION OF THE DRAWINGS

FIG. 1 is a diagram showing an example of a structure of an image scaling device according to an embodiment of the present invention;

FIG. 2 is a diagram showing an example of an effective range of an image processed by the image scaling device according to the embodiment;

FIG. 3 is a diagram for explaining an example of an operation principle of the image scaling device according to the embodiment;

FIG. 4 is a diagram showing another example of the effective range of the image processed by the image scaling device according to the embodiment;

FIG. 5 is a diagram for explaining another example of the operation principle of the image scaling device according to the embodiment;

FIG. 6 is a diagram for explaining a unit matrix and a data generation area used in the embodiment;

FIG. 7 is a diagram for explaining an interpolation position according to the embodiment;

FIG. 8 is a graph showing an example of an interpolation function used in the embodiment;

FIG. 9 is a diagram showing a position of a representative pixel when an image is enlarged by “s” times in the embodiment; and

FIG. 10 is a diagram for explaining the conventional problems.

### DETAILED DESCRIPTION OF THE PREFERRED EMBODIMENTS

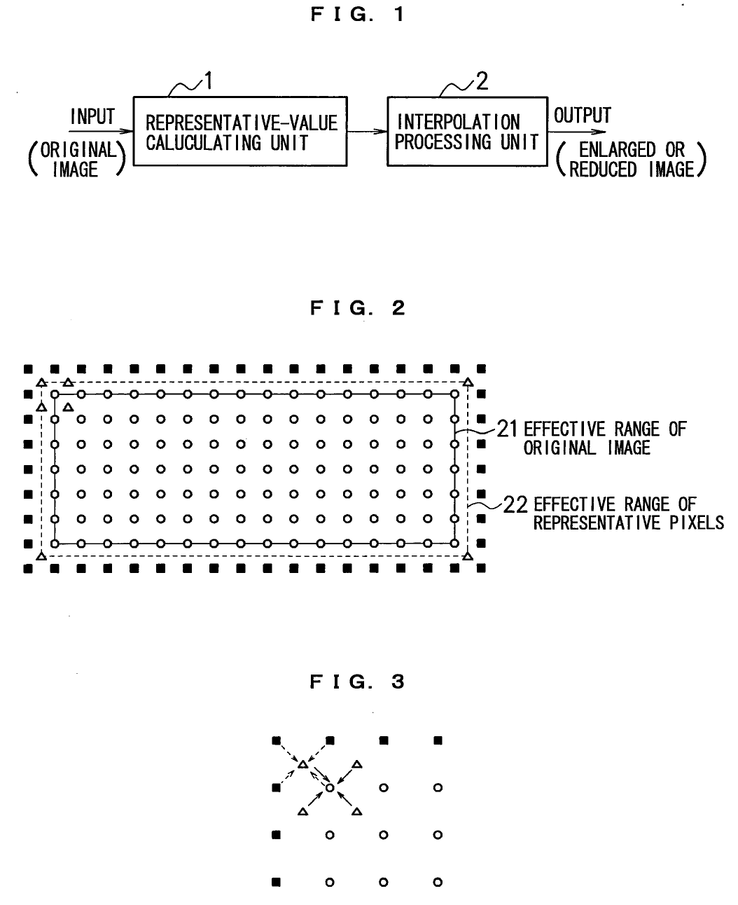

An embodiment of the present invention will be hereinafter explained with reference to the accompanying drawings. FIG. 1 is a diagram showing an example of a structure of an image scaling device according to this embodiment. FIG. 2 is a diagram showing an effective range of an image processed by the image scaling device according to this embodiment. FIG. 3 is a diagram for explaining an operation principle of the image scaling device according to this embodiment.

In FIG. 1, reference numeral 1 denotes a representative-value calculating unit. The representative-value calculating unit 1 calculates, with a range obtained by adding virtual pixels for “k” clocks (k is an integer equal to or larger than 1) on an outer side of an effective range of an original image set as a processing range, a representative value for each pixel block including m×n pixels (m and n are integers equal to or larger than 2) adjacent to one another in the processing range. Reference numeral 2 denotes an interpolation processing unit. The interpolation processing unit 2 calculates pixel values of respective pixels in an interpolation position corresponding to a predetermined scaling factor by applying an interpolation operation to the representative value calculated by the representative-value calculating unit 1.

FIGS. 2 and 3 show an example of processing for setting a pixel block including 2×2 pixels as a minimum pixel block (hereinafter referred to as unit matrix) to be subjected to enlargement and reduction processing for an image and enlarging or reducing an original image by one time. Here, one interpolated pixel value is set in an interpolation position corresponding to the scaling factor 1, i.e., the center of the unit matrix by applying the interpolation operation to four pixel values forming the unit matrix.

In FIG. 2, ◯ indicates effective pixels of the original image (original pixels) and a rectangle 21 of a solid line indicates an effective range of the original image. As shown in the figure, the original image is formed by plural pixels arranged at equal intervals on a two-dimensional space. ▪ indicates virtual pixels for “k” clocks (k=1 in the example in FIG. 2) added on an outer side of the original image. A range of an image including the virtual pixels is a processing range of an arithmetic operation by the representative-value calculating unit 1. A value of the virtual pixels is, for example, zero.

Δ indicates pixels having a representative value (representative pixels) and a rectangle 22 of a dotted line indicates an effective range of an image formed by the representative pixels. In FIG. 2, only a part of the representative pixels is shown. The effective range 22 of the image formed by the representative pixels is a range of an object of interpolation processing by the interpolation processing unit 2. Pixel values of the representative pixels indicated by Δ are objects of the interpolation operation by the interpolation processing unit 2.

As shown in FIG. 3, when the unit matrix is a pixel block including 2×2 pixels, the virtual pixels added on the outer side of the original image are pixels for 1 clock around the original image. A size of a pixel block set in calculating a representative value is also 2×2 pixels (m=n=2). The representative-value calculating unit 1 calculates a representative value for each pixel block including 2×2 pixels and arranges the representative value calculated in the center of the pixel block (arrows of dotted lines). As an arithmetic operation for calculating a representative value, it is possible to use an arithmetic operation for averaging four pixel values forming the pixel block.

The interpolation processing unit 2 sets a unit matrix for the representative pixels calculated by the representative-value calculating unit 1 and calculates pixel values of the respective pixels in an interpolation position (the center of the unit matrix) corresponding to the scaling factor 1 by applying the interpolation operation to the representative value of 2×2 pixels forming the unit matrix (arrows of solid lines). As it is evident from FIG. 3, positions of original pixels and positions of interpolated pixels coincide with each other.

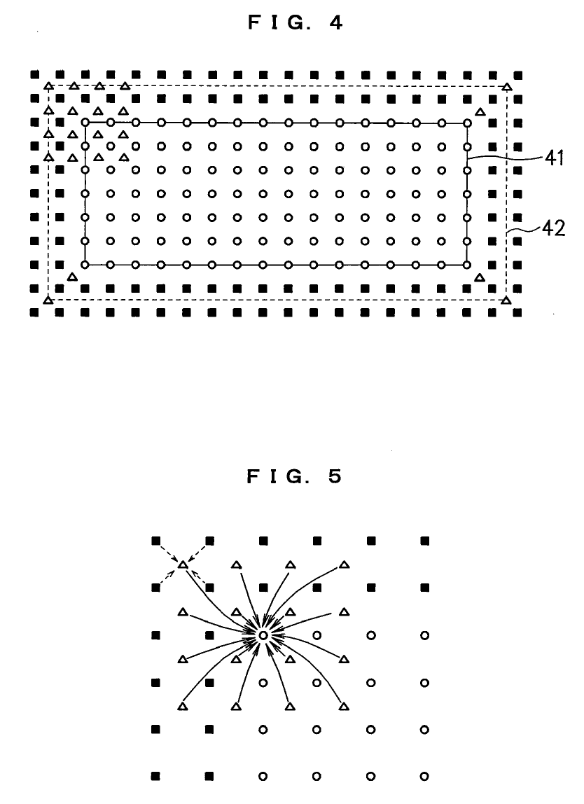

In the example explained here, the pixel block including 2×2 pixels is set as the unit matrix. However, the unit matrix is not limited to this. For example, a pixel block including 4×4 pixels may be set as a unit matrix. FIGS. 4 and 5 are diagrams showing an example of processing for setting a size of the unit matrix to 4×4 pixels and enlarging or reducing an original image by one time.

In FIG. 4, ◯ indicates effective pixels of an original image (original pixels). A rectangle 41 of a solid line indicates an effective range of the original image. ▪ indicates virtual pixels for “k” clocks (k=2 in the example in FIG. 4) added on an outer side of the original image. Δ indicates pixels having a representative value (representative pixels) and a rectangle 42 of a dotted line indicates an effective range of an image formed by the representative pixels. In FIG. 4, only a part of the representative pixels is shown.

As shown in FIGS. 4 and 5, when the unit matrix is a pixel block including 4×4 pixels, the virtual pixels added on the outer side of the original image are pixels for 2 clocks around the original image. A size of a pixel block set in calculating a representative value is 2×2 pixels. The representative-value calculating unit 1 calculates a representative value for each pixel block including 2×2 pixels and arranges the representative value calculated in the center of the pixel block.

The interpolation processing unit 2 sets a unit matrix for the representative pixels calculated by the representative-value calculating unit 1 and calculates pixel values of the respective pixels in an interpolation position (the center of the unit matrix) corresponding to the scaling factor 1 by applying the interpolation operation to representative values of 4×4 pixels forming the unit matrix. As it is evident from FIGS. 4 and 5, positions of original pixels and positions of interpolated pixels coincide with each other.

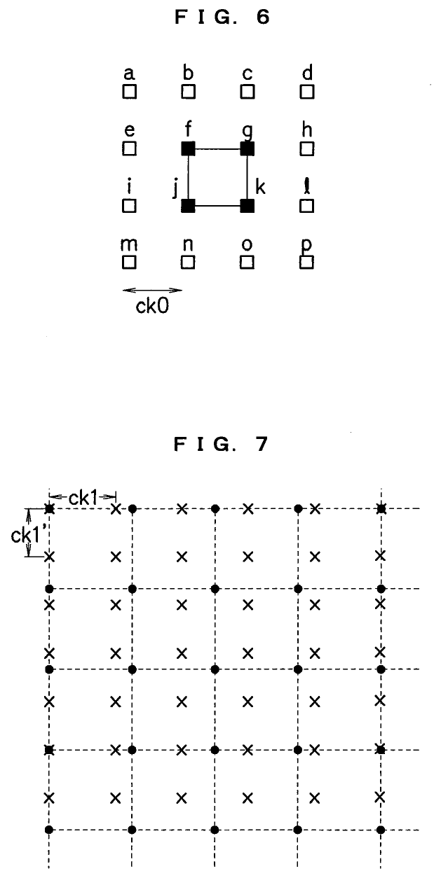

In the example explained above, the original image is enlarged or reduced by one time to facilitate understanding of the explanation. However, in enlarging or reducing the original image by “s” times, the interpolation operation by the interpolation processing unit 2 is performed, for example, as described below. FIGS. 6 to 8 are diagrams for explaining an example of the interpolation operation performed when the pixel block of 4×4 pixels is set as a unit matrix.

FIG. 6 is a diagram for explaining the unit matrix and a data generation area set in the center of the unit matrix. In FIG. 6, 4×4 representative pixels “a” to “p” indicated by squares (equivalent to those indicated by Δ in FIG. 5) are pixels forming the unit matrix. A clock interval of pixels adjacent to each other in the horizontal direction is ck0. A clock interval of pixels adjacent to each other in the vertical direction is 1 horizontal clock. The data generation area is a square area (an area surrounded by four pixels “f”, “g”, “j”, and “k” adjacent to one another) in the center of the unit matrix. Interpolation data is generated in this data generation area.

A method of generating interpolation data is as described below. An interpolation position is set in the data generation area according to an enlargement or reduction ratio “s” of an image and spatial distances between the interpolation position set and positions of the sixteen pixels “a” to “p” are calculated, respectively. Coefficient values corresponding to the spatial distances are calculated from a predetermined interpolation function. Interpolation data is generated by multiplying the pixel values of the pixels “a” to “p” by the coefficient values calculated for the pixels “a” to “p”, respectively, and adding up all results of the multiplication.

The interpolation position will be explained. FIG. 7 is a diagram for explaining the interpolation position. In FIG. 7, ● indicates representative pixels calculated by the representative-value calculating unit 1 and X indicates pixels of an interpolated image obtained by enlarging an image by sH times in the horizontal direction and sV times in the vertical direction (sH and sV are arbitrary positive numbers. FIG. 7 shows an example in which sH≠sV, 1<sH<2, and 1<sV<2). Each of rectangular areas of dotted lines. surrounded by four representative pixels indicates the data generation area.

Enlarging the image by sH times in the horizontal direction is equivalent to setting interpolation positions at intervals 1/sH times as small as pixel intervals in the horizontal direction, calculating pixel values of the interpolation positions according to the interpolation operation, and drawing the pixel values of the interpolation positions calculated at original pixel intervals same as those of the original image. Calculating interpolation data of the interpolation positions set at the intervals of 1/sH times as small as the pixel intervals is equivalent to resampling points at intervals of clock ck1 of a frequency sH times as large as a reference clock ck0 (ck1=sH*ck0) and calculating interpolation data of the resample points.

In this case, positions in the horizontal direction of the resample points in the data generation area are shifted at an interval of 1/sH every 1 clock ck1 as shown in FIG. 7. The positions coincide with the original pixel positions after several clocks of ck1. In the case of the example in FIG. 7, the positions in the horizontal direction of the resample points in the data generation area coincide with the original pixel positions in positions five interpolation pixels ahead (four representative pixels ahead).

Enlarging the image by sV times in the vertical direction is equivalent to setting interpolation positions at intervals 1/sV times as small as pixel intervals in the horizontal direction, calculating pixel values of the interpolation positions according to the interpolation operation, and drawing the pixel values of the interpolation positions calculated at original pixel intervals same as those of the original image. Calculating interpolation data of the interpolation positions set at the intervals of 1/sV times as small as the pixel intervals is equivalent to resampling points at intervals of clock ck1′ of a frequency sV times as large as the reference clock ck0 (ck1′=sV*ck0) and calculating interpolation data of the resample points.

In this case, positions in the vertical direction of the resample points in the data generation area are shifted at an interval of 1/sV every 1 clock ck1′ as shown in FIG. 7. The positions coincide with the original pixel positions after several clocks of ck1′. In the case of the example in FIG. 7, the positions in the vertical direction of the resample points in the data generation area coincide with the original pixel positions in positions five interpolation pixels ahead (three representative pixels ahead).

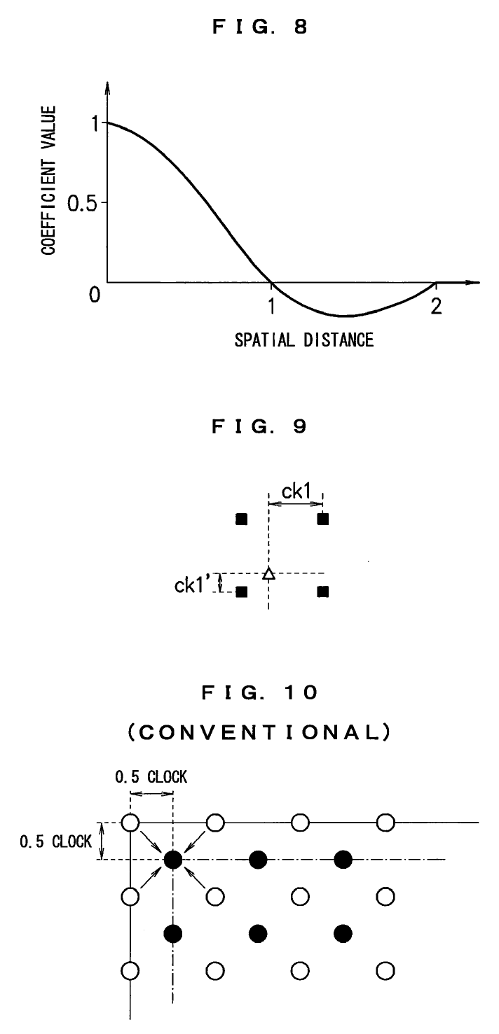

FIG. 8 is a diagram showing an example of an interpolation function used in calculating interpolation data. In the interpolation function shown in FIG. 8, a coefficient value is 1 when a spatial distance between an interpolation position and an original pixel position is 0, the coefficient value is 0 when the spatial distance is 1 (equivalent to one reference clock ck0), and the coefficient value is 0 when the spatial distance is equal to or larger than 2. The interpolation function is set such that the coefficient value is a positive value when the spatial distance is larger than 0 and smaller than 1 and the coefficient value is a negative value when the spatial distance is larger than 1 and smaller than 2.

As described above, the unit matrix is set in the area of 4×4 pixels. The data generation area is set in the range of 2×2 pixels in the center of the unit matrix. Therefore, a spatial distance between an interpolation position set in the data generation area and a position of a certain pixel on the outside of the unit matrix is always equal to or larger than 2. When the interpolation function shown in FIG. 8 is used, if the spatial distance is equal to or larger than 2, the coefficient value is always 0. Therefore, the pixel values of the representative pixels on the outside of the unit matrix do not affect the interpolation data. In other words, the interpolation operation is completed using only the pixel values in the unit matrix.

As described above, even when the original image is enlarged by “s” times (sH times in the horizontal direction and sV times in the vertical direction), the representative-value calculating unit 1 calculates a representative value for each pixel block including 2×2 pixels adjacent to one another in the processing range obtained by adding the virtual pixels to the original pixels. An arrangement position of the representative value calculated in the pixel block is different from that when the original image is enlarged by one time. As shown in FIG. 9, the representative pixel is arranged in a position apart by the interval of the clock ck1 of the sH time frequency in the left direction from a pixel on a right row side and apart by the interval of the clock ck1′ of the sV time frequency in the up direction from a pixel on a lower row side among four pixels forming one pixel block.

The interpolation processing unit 2 calculates pixel values of the respective pixels in the interpolation position corresponding to the enlargement or reduction ratios sH and sV by applying the interpolation operation explained with reference to FIGS. 6 and 8 to the representative value calculated by the representative-value calculating unit 1. In this case, the interpolation position is shifted by the clock ck1 of the sH time frequency in the right direction from a pixel on a left row side and by the clock ck1′ of the sV time frequency in the down direction from a pixel on an upper row side in the data processing block formed by the four representative pixels. Consequently, the interpolation position coincides with the position of the original pixel.

As explained above in detail, in this embodiment, the virtual pixels for “k” clocks are added on the outer side of the effective pixels of the original image according to a size of the unit matrix, which is the minimum pixel block in performing the interpolation processing. In the processing range including the virtual pixels, a representative value is calculated for each pixel block including m×n pixels adjacent to one another and pixel values of the respective pixels in the interpolation position corresponding to a predetermined scaling factor are calculated by applying the interpolation operation to the representative value calculated.

Consequently, an effective range of an image formed by the representative value is shifted further to the outer side than the effective range of the original image by a predetermined amount. When the interpolation operation is applied to the representative value, the effective range of which is shifted to the outer side, the effective range of the image formed by the interpolation value is shifted to the inner side by a predetermined amount. However, an effective range obtained as a result of the shift is the same as the effective range of the original image. Therefore, even when enlargement or reduction of an image is performed by the interpolation processing, it is possible to prevent the inconvenience that a peripheral portion of the original image is lost.

The image scaling device according to this embodiment explained above may be realized by a hardware configuration. It is also possible to realize the image scaling device with a DSP (Digital Signal Processor), software, a gate array, an FPGA (Field Programmable Gate Array), and the like. For example, when the image scaling device is realized by software, the image scaling device actually includes a CPU or an MPU, a RAM, a ROM, and the like of a computer. It is possible to realize the image scaling device according to the operation of a program stored in the RAM or the ROM.

Therefore, it is possible to realize the image scaling device by recording a program for causing the computer to play the functions of the embodiment in a recording medium such as a CD-ROM and causing the computer to read the program. As the recording medium that records the program, besides the CD-ROM, it is possible to use a flexible disk, a hard disk, a magnetic tape, an optical disk, a magneto-optical disk, a DVD, a nonvolatile memory card, and the like. It is also possible to realize the image scaling device by downloading the program to the computer through a network such as the Internet.

In the example explained in the embodiment, an arithmetic operation for averaging the four pixel values forming the pixel block is used as the arithmetic operation for calculating a representative value. However, the present invention is not limited to this. For example, representative values of representative pixels may be calculated by interpolation processing same as that performed by the interpolation processing unit 2 using a predetermined interpolation function (e.g., the interpolation function shown in FIG. 8).

It is possible to apply the image scaling device according to this embodiment to enlargement and reduction of a still image and enlargement and reduction of a moving image. In the embodiment, the virtual pixels for “k” clocks are added around the original image. However, in the case of the moving image, the present invention is not limited to this. For example, a blanking period for at least “k” clocks may be set around an effective range of an original image to treat a value (zero) in the blanking period as a virtual pixel.

In the example explained in the embodiment, the pixel values of the virtual pixels are set to zero. However, the present invention is not limited to this. For example, values same as pixel values of pixels located in an outermost periphery of an original image may be set as the pixel values of the virtual pixels.

Besides, the above-mentioned embodiment only indicates an example of materialization in carrying out the present invention. The technical scope of the present invention should not be limitedly interpreted by the embodiment. In other words, it is possible to carry out the present invention in various forms without departing from the spirit or main characteristics thereof.

What is claimed is:

1. An image scaling device that applies image enlargement or reduction to an original image formed by plural pixels arranged at equal intervals on a two-dimensional space by calculating pixel values of the respective pixels in an interpolation position corresponding to a predetermined scaling factor from pixel values of the original image around the interpolation position according to an interpolation operation, the image scaling device comprising:
a representative-value calculating unit that, with a range obtained by adding virtual pixels for “k” clocks on an outer side of effective pixels of the original image set as a processing range, calculates a representative value for each pixel block including m×n pixels (m and n are integers equal to or larger than 2) adjacent to one another in the processing range; and
an interpolation processing unit that calculates the pixel values of the respective pixels in the interpolation position corresponding to the predetermined scaling factor by applying the interpolation operation to the representative value calculated by the representative-value calculating unit.
